(19) United States
(12) Patent Application Publication
(10) Pub. No.: US 2015/0004494 A1
(43) Pub. Date: Jan. 1, 2015

(54) Multilayer Si/Graphene Composite Anode Structure

(71) Applicant: National Taiwan University of Science and Technology, Taipei (TW)

(72) Inventors: Mori Tatsuhiro, Taipei (TW); Chih-Jung Chen, Taipei (TW); Tai-Feng Hung, Taipei (TW); Saad G. Mohamed, Taipei (TW); Ru-Shi Liu, Taipei (TW); Shu-Fen Hu, Taipei (TW); Hong-Zheng Lin, Taipei (TW); Yi-Qiao Lin, Taipei (TW); Chien-Ming Sung, Taipei (TW); Bing-Joe Hwang, Taipei (TW)

(21) Appl. No.: 14/314,895

(22) Filed: Jun. 25, 2014

(30) Foreign Application Priority Data
Jun. 26, 2013 (TW) 102122827

(51) Int. Cl. H01M 4/36; H01M 4/38; H01M 4/04; H01M 4/583

(52) U.S. Cl. CPC H01M 4/366; H01M 4/583; H01M 4/386; H01M 4/0423
USPC 429/231.8; 427/551

(57) ABSTRACT

The present invention discloses a high electrochemical performance silicon/graphene composite anode structure. The electrochemical properties of silicon in the composite anode structure can be improved by graphene thin films. The thickness of the silicon thin film and the graphene thin films is less than 50 nm to prevent the composite anode structure from any volumetric change during the charge/discharge process. The manufacturing procedure starts with the formation of a Si/graphene unit layer, which includes an amorphous phase upper silicon thin film and a lower graphene thin film, on a copper foil current collector, so as to decrease the difference of conductivity between the silicon thin film and the copper foil current collector. Finally, the deposition is concluded with the formation of a graphene thin film on the topmost surface of the silicon thin film to prevent the surface of the anode structure from oxidation.

### RELATED APPLICATIONS

This application claims benefit of Taiwan Patent Application No. 102122827, filed on Jun. 26, 2013, at the Taiwan Intellectual Property Office, the entire disclosure of which is incorporated herein by reference.

### FIELD OF THE INVENTION

The present invention relates to a multilayer Si/graphene composite anode structure having excellent electrochemical properties.

### BACKGROUND OF THE INVENTION

In 2012, Ji et al. (referring to Liwen Ji et al., Graphene/Si multilayer structure anodes for advanced half and full lithium-ion cells. Nano Energy. 2012. 1(1): 164-171.) manufactured a thin film from a graphene solution with vacuum filtration, transferred the thin film onto a copper foil current collector, and then formed the silicon (Si) thin film on the surface of the thin film using plasma-enhanced chemical vapor deposition (PECVD). By repeating the above process several times, the Si/graphene multilayer composite, acting as an anode of a battery, can be successfully prepared, wherein a sample with 5 layers of the Si/graphene structure has the best electrochemical properties. However, in the charge/discharge test at the current density of 50 mA/g, the discharge capacity of such a sample during the 30^{th} cycle declined to 59.5% of the discharge capacity of the first cycle.

In the same year, Zhang et al. (referring to Y. Q. Zhang et al., Silicon/graphene-sheet hybrid film as anode for lithium ion batteries. Electrochemistry Communications. 2012. 23: 17-20.) prepared a silicon/graphene multilayer composite material as an anode of a battery on the copper foil current collector using electrophoretic deposition (EPD) and radio frequency (RF) magnetron sputter methods. In the charge/discharge test at the current density of 840 mA/g, the discharge capacity during the first cycle was 3150 mAh/g. Because the weight of silicon material was not taken into account in this research when determining the discharge capacity, the actual discharge capacity of the composite material was much lower than 3150 mAh/g. It is more important that the coulombic efficiency of the silicon/graphene multilayer composite material in the first charge/discharge cycle was only 71.9%, and the discharge capacity in the second charge/discharge cycle declined to about 2000 mAh/g. Therefore, the reversible capacity was only 63.5%.

In 2012, Kim et al. (referring to U.S. Pat. No. 8,168,328 B2) disclosed a multilayer carbon/Si composite anode structure, wherein a so-called “interface stabilizing layer” including a silicide compound must be formed between the carbon/Si interfaces of the multilayer carbon/Si composite anode structure using annealing.

It is therefore the Applicant's intent to deal with the above limitations of prior art.

### SUMMARY OF THE INVENTION

The present invention discloses a multilayer Si/graphene composite anode structure prepared using Electron Beam Evaporation, in which the electrochemical properties of the silicon thin film are improved because of the advantageously high conductivity of graphene. Furthermore, both the thicknesses of the graphene thin film and of the silicon thin film are controlled at less than 50 nm to minimize the volumetric change of the anode material.

First, a graphene thin film is deposited onto the surface of the copper foil current collector to form the underside surface of the structure, so that the considerably large difference of conductivity between the current collector and the silicon thin film is can avoid the problem of poor electrochemical performance. To prevent the silicon thin film from being exposed to the air and from being oxidized into inactive silicon dioxide, the top surface of the structure is made of a graphene thin film.

In the anode material, an upper silicon thin film and a lower graphene thin film constitute a unit layer. The unit layer is duplicated to form the number of layers as needed, and finally a graphene thin film is deposited as the top surface. Thus, the preparation of the multilayer Si/graphene composite anode structure is completed, in which the multilayer Si/graphene composite anode structure with 7 repeated unit layers has better electrochemical performance. The coulombic efficiency of the multilayer Si/graphene composite anode structure in the first cycle is higher than 80%, and the irreversible capacity in the second cycle declines to less than 20%. In addition, the discharge capacity of multilayer Si/graphene composite anode structure after 30 charge/discharge cycles still retains more than 65% of that in the first cycle.

As yet there is no study, which discloses a multilayer Si/graphene composite anode structure without an interface stabilizing layer but having a high capacity and achieving the electrochemical performance as described above.

The present invention also discloses a method for preparing a multilayer Si/graphene composite anode structure with superior electrochemical properties. Direct sequential coating is adopted in the method, and an interface stabilizing layer (which may include a silicide layer) and the complicated annealing process are unnecessary. The preparation technique is Electron Beam Evaporation, wherein the pressure in the Electron Beam Evaporation chamber is kept between 4˜10 Pa and the temperature of the substrates is controlled at 200° C. The electron beam hits the graphite target to form a first graphene thin film and the coating velocity of the graphene thin film is 1000 nm/h, and then the electron beam hits the silicon target to deposit a silicon thin film on the first graphene thin film at a coating velocity of 500 nm/h. A second graphene thin film is subsequently deposited onto the preceding silicon thin film. The structure of the present invention is formed by repeating the processes above.

### BRIEF DESCRIPTION OF THE DRAWINGS

FIG. 1 is a structure diagram of the multilayer Si/graphene composite anode structure according to an embodiment of the present invention, wherein a silicon thin film 11 and a graphene thin film 12 constitute a unit layer.

FIG. 2 is an X-ray powder diffraction spectrums of the multilayer Si/graphene composite anode structure prepared using Electron Beam Evaporation according to the embodiment in the present invention. From top to bottom, 9L, 7L, 5L, 3L, 1L and Cu represent the diffraction spectra of 9 unit layers, 7 unit layers, 5 unit layers, 3 unit layers, 1 unit layer and the copper foil 13, respectively.

FIG. 3 is a transmission electron microscopy image of the multilayer Si/graphene composite anode structure, which was prepared using Electron Beam Evaporation, according to the embodiment in the present disclosure.

FIG. 4 is a Raman spectrum of the 7-unit layers Si/graphene composite anode structure, which was prepared using Electron Beam Evaporation, according to the embodiment in the present disclosure.

FIG. 5(A) and FIG. 5(B) are (A) a cyclic life diagram and (B) a charge/discharge test diagram for a 1-unit layer (1L) Si/graphene composite anode structure according to the embodiment in the present disclosure.

FIG. 6(A) and FIG. 6(B) are (A) a cyclic life diagram and (B) a charge/discharge test diagram for a 3-unit layer (3L) Si/graphene composite anode structure according to the embodiment in the present disclosure.

FIG. 7(A) and FIG. 7(B) are (A) a cyclic life diagram and (B) a charge/discharge test diagram for a 5-unit layer (5L) Si/graphene composite anode structure according to the embodiment in the present disclosure.

FIG. 8(A) and FIG. 8(B) are (A) a cyclic life diagram and (B) a charge/discharge test diagram for a 7-unit layer (7L) Si/graphene composite anode structure according to the embodiment in the present disclosure.

FIG. 9(A) and FIG. 9(B) are (A) a cyclic life diagram and (B) a charge/discharge test diagram for a 9-unit layer (9L) Si/graphene composite anode structure according to the embodiment in the present disclosure.

FIG. 10 is a diagram showing the number of layers in the multilayer Si/graphene composite anode structure versus the discharge capacity in the first cycle according to the embodiment in the present disclosure.

FIG. 11 is a diagram showing the number of layers in the multilayer Si/graphene composite anode structure versus the coulombic efficiency in the first cycle according to the embodiment in the present disclosure.

FIG. 12 is a diagram showing the number of layers in the multilayer Si/graphene composite anode structure versus the coulombic efficiency in the second cycle according to the embodiment in the present disclosure.

### DETAILED DESCRIPTION OF THE PREFERRED EMBODIMENT

The multiple layers of the Si/graphene composite anode materials are deposited continuously onto the surface of the copper foil current collector using Electron Beam Evaporation. The pressure in the deposition chamber is kept between 4˜10 Pa, the temperature of the substrates is controlled between 150˜250° C., and the coating velocities of the graphene thin film 12 and the silicon thin film 11 are about 1000 nm/h and 500 nm/h, respectively. In the preparation steps, the graphene thin film 12 is deposited onto the copper foil current collector first, followed by the interchanging depositions of silicon, graphene, silicon, graphene and so on, and the topmost thin film is necessarily a graphene thin film 12. The electrochemistry properties of the multilayer Si/graphene composite anode structure was subjected to a charge/discharge test, wherein the anode structure was assembled as a coin cell battery with lithium metal using an electrolytic solution in which lithium hexafluorophosphate (LiPF₆) was dissolved in ethylene carbonate (EC) and dimethyl carbonate (DMC), and the charge/discharge test was performed at a current density of 100 mA/g.

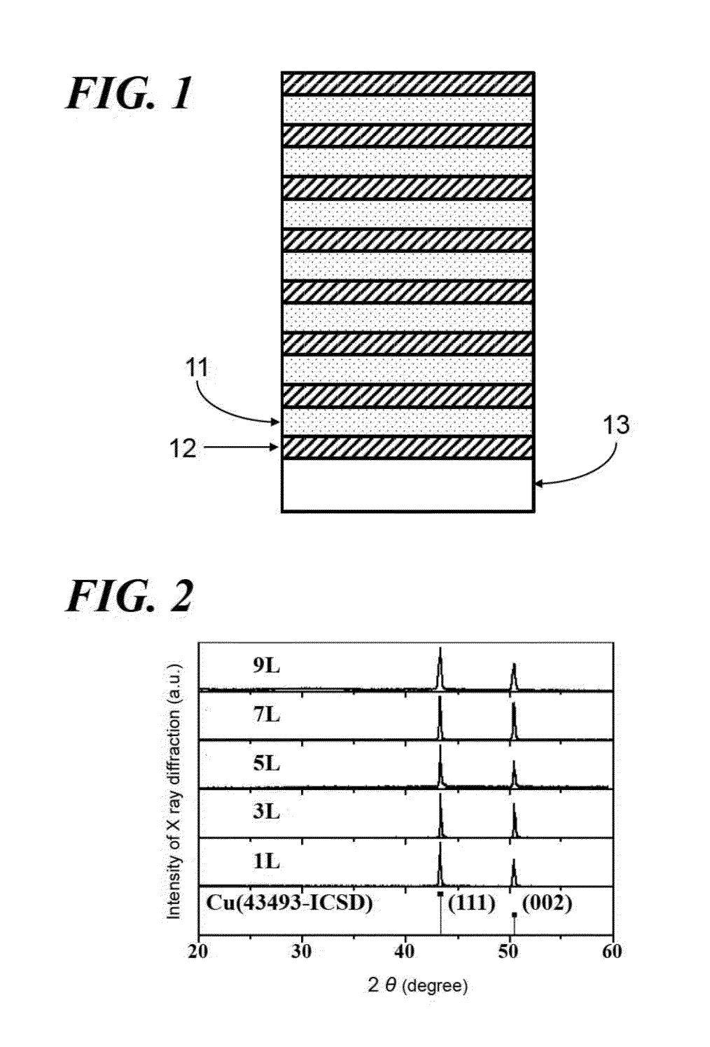

Please refer to FIG. 1, which is a structural diagram of the multilayer Si/graphene composite anode structure to the embodiment in the present invention. The manufacturing process begins and ends with the deposition of the graphene thin film 12, which is able to minimize the difference in conductivity between the silicon thin film 11 and the copper foil 13 and prevent the silicon thin film 11 from oxidation which could result from exposure to the air.

Please refer to FIG. 2, the morphology and crystal structures of the graphene deposited in different layers are observed by X-ray powder diffractometer. Through the characteristics of the diffraction pattern shown in FIG. 2, it can be confirmed that each graphene layer is structurally identical and is materially composed of graphene.

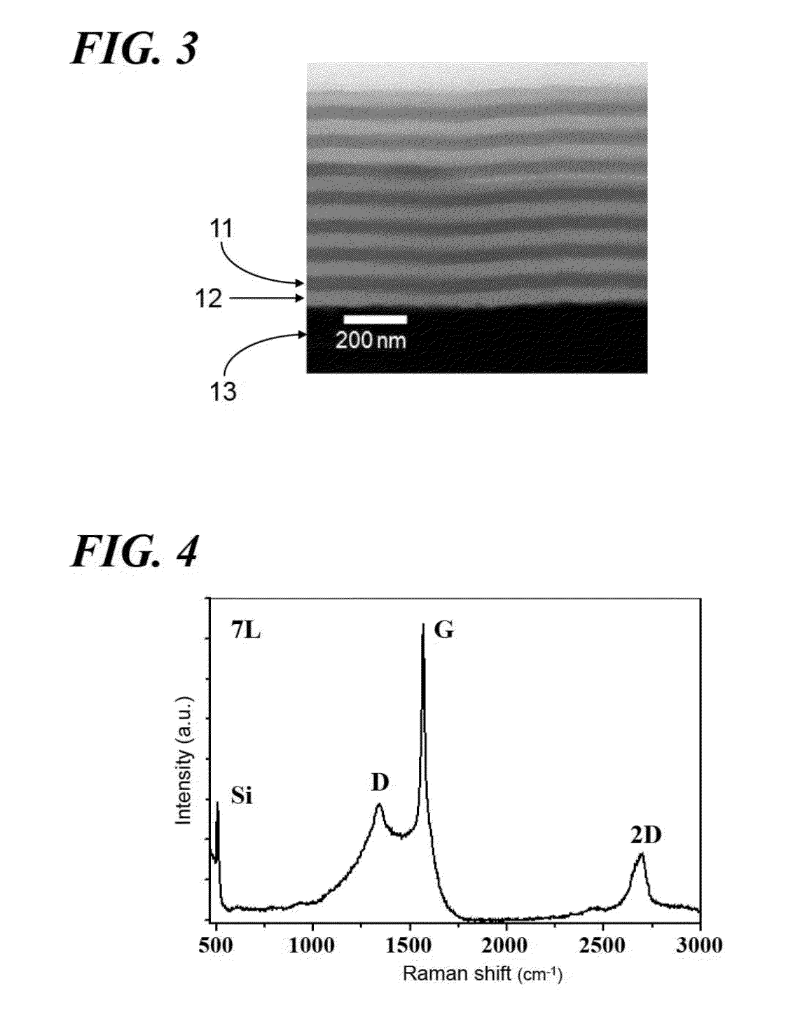

Please refer to FIG. 3, which is a transmission electron microscopic image of the multilayer Si/graphene composite anode structure in the present invention. The thickness of all thin film materials is controlled to be less than 50 nm to prevent any severe volumetric change during charge/discharge.

Please refer to FIG. 4, which is a Raman spectrum of the multilayer Si/graphene composite anode structure in the present invention. The Raman signal of silicon can be found at 505 cm⁻¹, and in addition, the Raman signals of the D band, G band and 2D band of graphene can be found at 1339 cm⁻¹, 1569 cm⁻¹ and 2697 cm⁻¹ respectively. The existence of the D band indicates that there are a few defects in the graphene structures, which enable the lithium ions to move in and out.

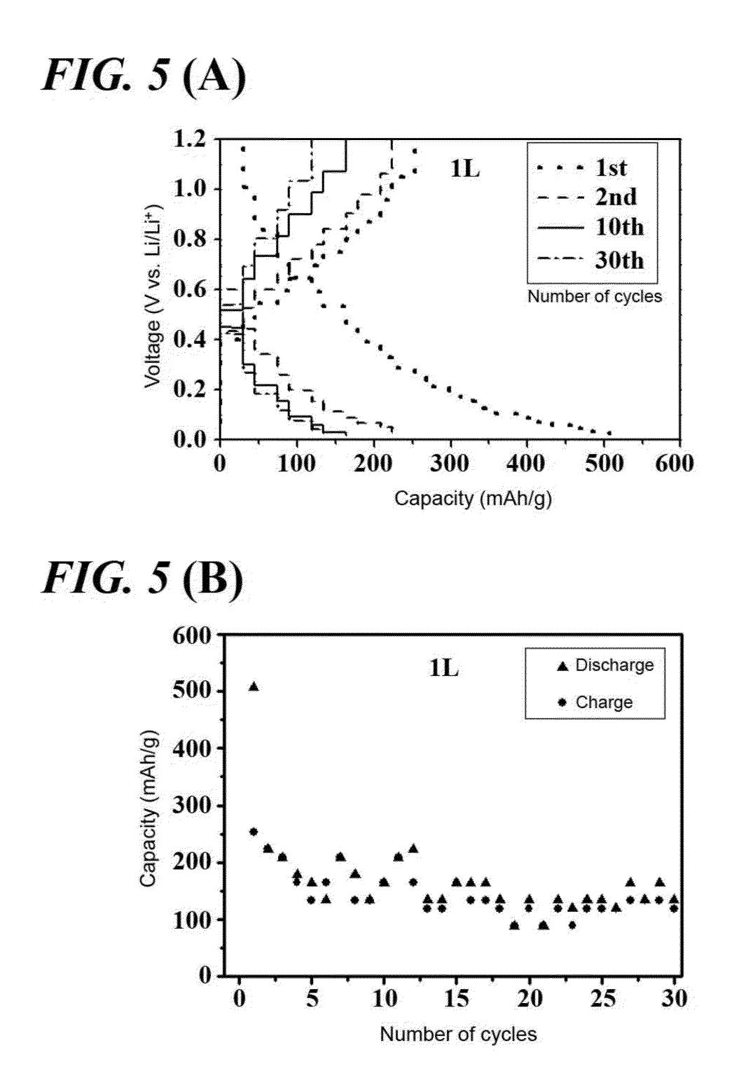

Please refer to FIG. 5(A) and FIG. 5(B), which are (A) a cyclic life diagram and (B) a charge/discharge test diagram for the 1-unit layer (1L) Si/graphene composite anode structure in the present disclosure. The discharge capacity and the coulombic efficiency of the ‘1L’ structure in the first cycle are 552 mAh/g and 53.8% respectively, and the reversible capacity in the second cycle is 48.3%.

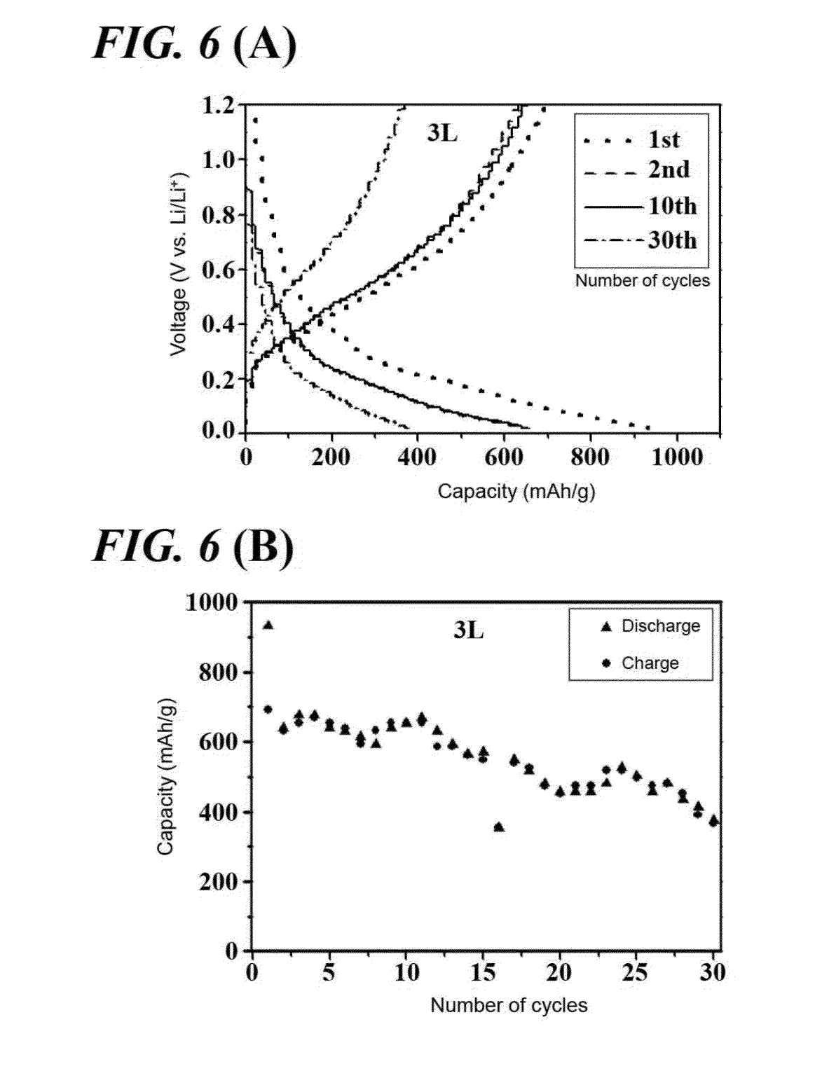

Please refer to FIG. 6(A) and FIG. 6(B), which are (A) a cyclic life diagram and (B) a charge/discharge test diagram for the 3-unit layer (3L) Si/graphene composite anode structure in the present disclosure. The discharge capacity and the coulombic efficiency of the ‘3L’ structure in the first cycle are 1090 mAh/g and 76.3% respectively, and the reversible capacity in the second cycle is 73.3%.

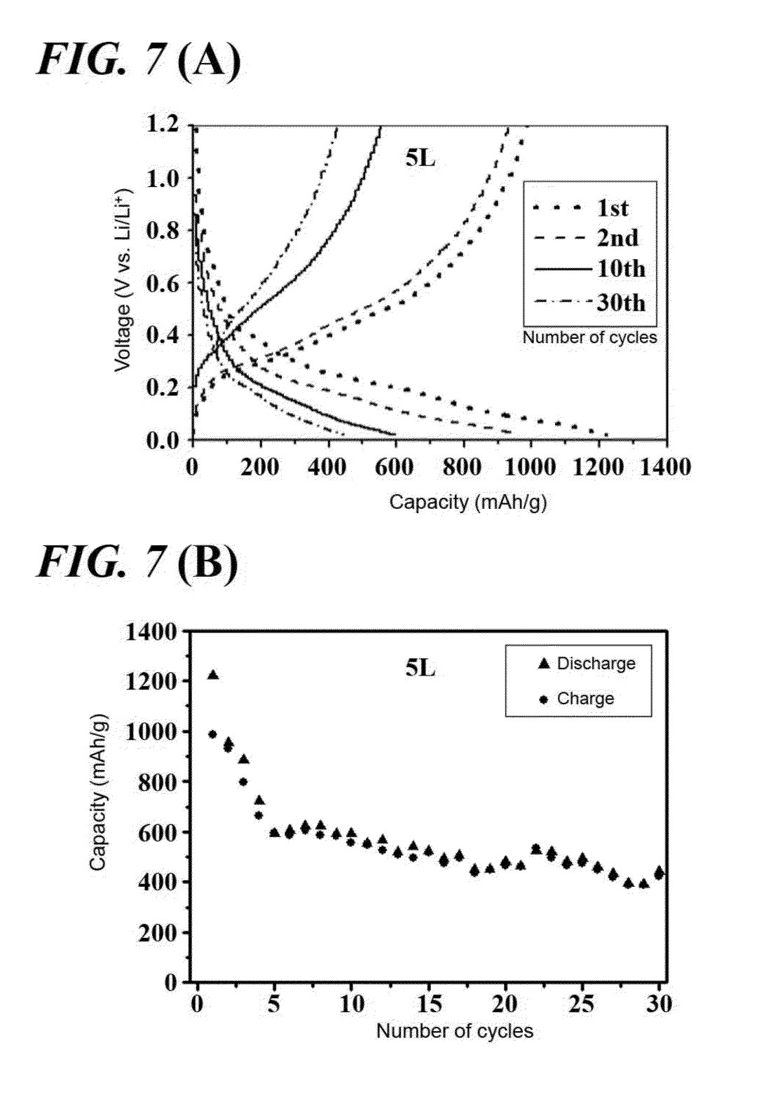

Please refer to FIG. 7(A) and FIG. 7(B), which are (A) a cyclic life diagram and (B) a charge/discharge test diagram for the 5-unit layer (5L) Si/graphene composite anode structure in the present disclosure. The discharge capacity and the coulombic efficiency of the ‘5L’ structure are 1110 mAh/g and 79.8% respectively, and the reversible capacity in the second cycle is 77.7%.

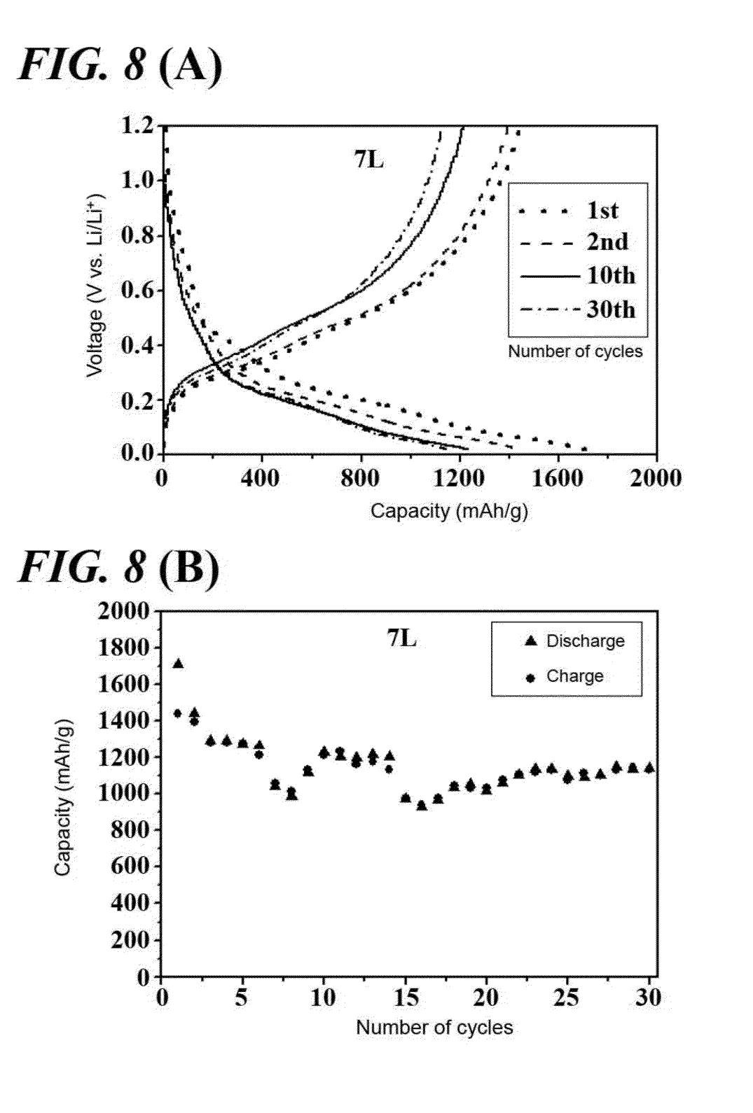

Please refer to FIG. 8(A) and FIG. 8(B), which are (A) a cyclic life diagram and (B) a charge/discharge test diagram for the 7-unit layer (7L) Si/graphene composite anode structure in the present disclosure. The discharge capacity and the coulombic efficiency of the ‘7L’ structure are 1660 mAh/g and 82.3% respectively, and the reversible capacity in the second cycle is 84.3%.

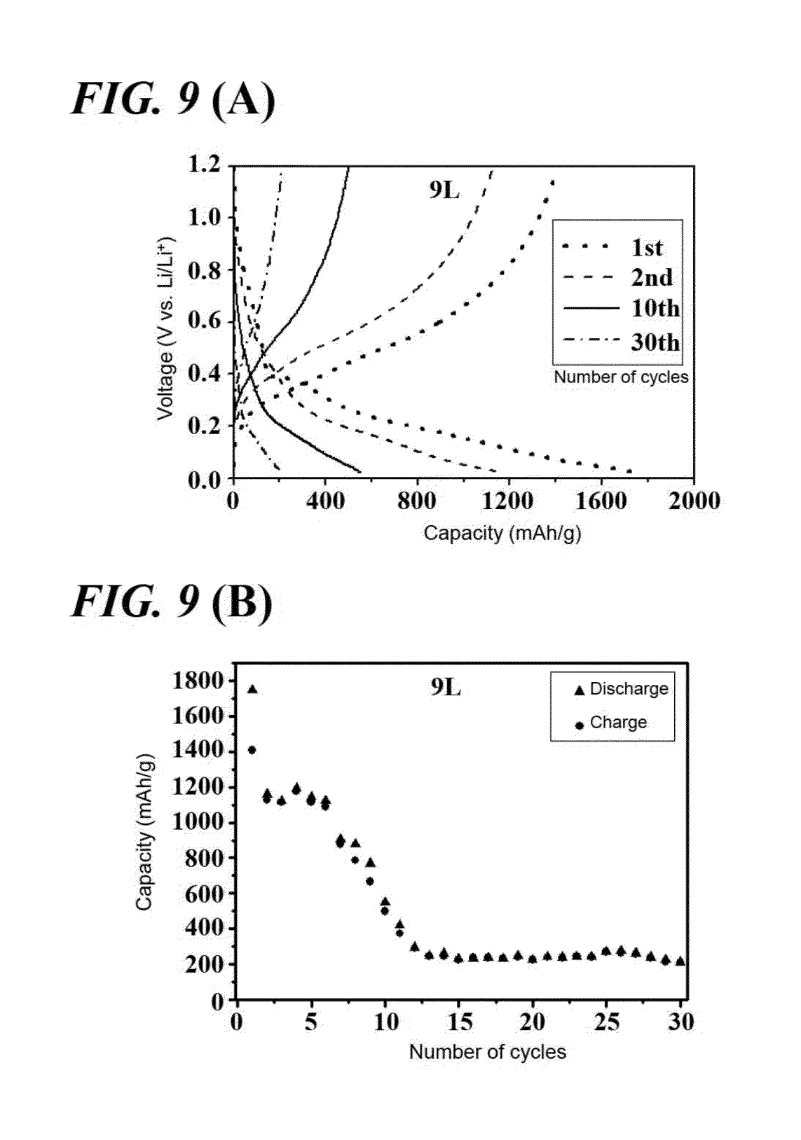

Please refer to FIG. 9(A) and FIG. 9(B), which are (A) a cyclic life diagram and (B) a charge/discharge test diagram for the 9-unit layer (9L) Si/graphene composite anode structure in the present disclosure. The discharge capacity and the coulombic efficiency of the ‘9L’ structure are 1719 mAh/g and 81.0% respectively, and the reversible capacity in the second cycle is 65.4%.

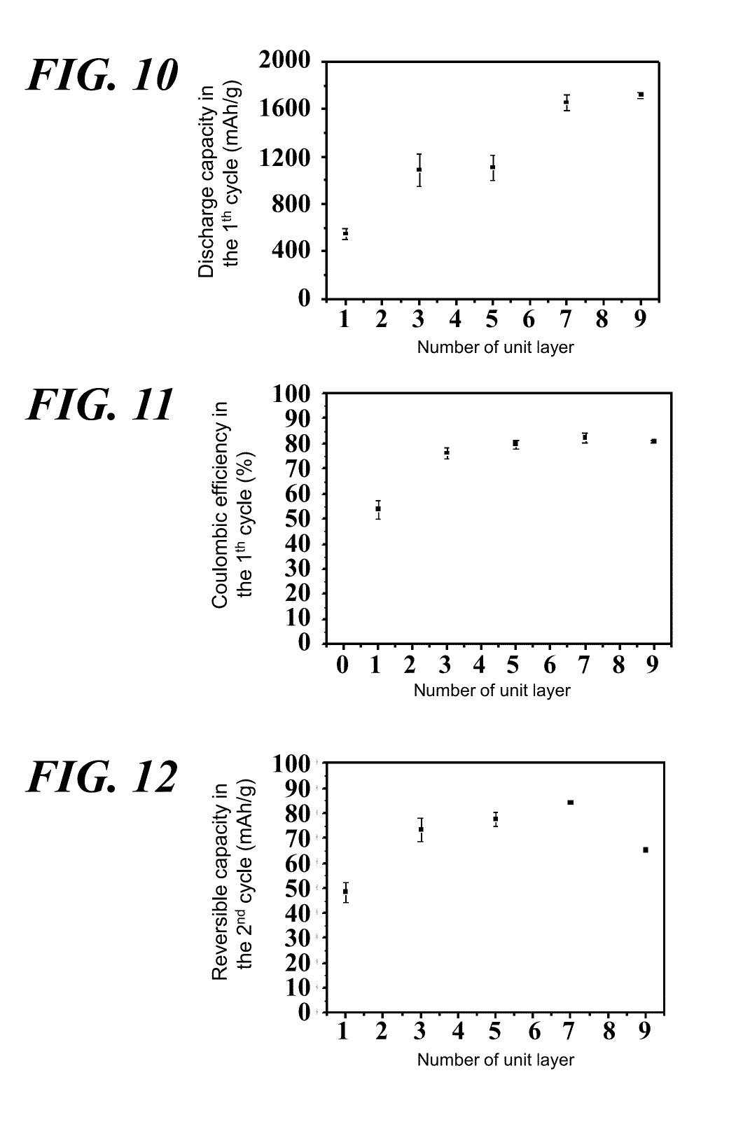

Please refer to FIG. 10, which shows the relationship between the number of unit layers in the multilayer Si/graphene composite anode structures of the present invention and the discharge capacity in the first cycle. It can be seen that the capacity becomes saturated when the number of unit layers is increased to 7.

Please refer to FIG. 11, which shows the relationship between the number of layers in the multilayer Si/graphene composite anode structures in the present disclosure and the coulombic efficiency in the first cycle. It can be seen that the 7-unit layer structure has the highest coulombic efficiency.

Please refer to FIG. 12, which shows the relationship between the number of layers in the multilayer Si/graphene composite anode structure in the present disclosure and the reversible capacity in the second cycle. It can be seen that the 7-unit layer structure has the largest reversible capacity.

### EMBODIMENTS

Embodiment 1: A multilayer Si/graphene composite anode structure, which is deposited onto an anode substrate using Electron Beam Evaporation, includes at least one Si/graphene unit layer and a graphene thin film. The at least one Si/graphene unit layer has an amorphous phase upper silicon thin film and a lower graphene thin film, and each Si/graphene unit layer is stacked on each other in parallel. A graphene thin film is deposited on the topmost silicon thin film.

Embodiment 2: In the multilayer Si/graphene composite anode structure according to Embodiment 1, the number of the Si/graphene unit layers is preferably 7.

Embodiment 3: In the multilayer Si/graphene composite anode structure according to any one of Embodiments 1 and 2, the anode substrate is preferably a copper foil.

Embodiment 4: In the multilayer Si/graphene composite anode structure according to any one of Embodiments 1 to 3, the amorphous phase upper silicon thin film, the lower graphene thin film and the graphene thin film are preferably 50 nm.

Embodiment 5: In the multilayer Si/graphene composite anode structure according to any one of Embodiments 1 to 4, the multilayer Si/graphene composite anode structure consists of 7 Si/graphene unit layers, and the graphene thin film which acts as the top surface of the entire structure.

Embodiment 6: In the charge/discharge test at the current density of less than 100 mAh/g, the capacity of the 7-unit layer Si/graphene composite anode structure according to Embodiment 5 is larger than 1000 mAh/g.

Embodiment 7: In the charge/discharge test according to Embodiment 6, the coulombic efficiency of the 7-unit layer anode structure in the first charge/discharge cycle is larger than 80%, the irreversible capacity in the second charge/discharge cycle is less than 20%, and after 30 charge/discharge cycles, the discharge capacity is larger than 65% of the discharge capacity of the first charge/discharge cycle.

Embodiment 8: A manufacturing method of an electrode structure including: keeping the internal pressure of the Electron Beam Evaporation chamber between 4˜10 Pa, keeping the temperature inside the

Electron Beam Evaporation chamber between 150˜200° C. and sequentially and repeatedly depositing the graphene thin film and the silicon thin film.

Embodiment 9: In the manufacturing method according to Embodiment 8,the coating velocity of the graphene thin film is 1000 nm/h, and that of the silicon thin film is 500 nm/h.

Embodiment 10: In the manufacturing method according to any one of Embodiment 8 to 9, wherein the steps of depositing the graphene thin film and a silicon thin film are repeated 7 times.

Embodiment 11: The manufacturing method according to Embodiment 10 is completed with a final deposit of graphene thin film.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A multilayer composite anode structure deposited onto an anode substrate using an Electron Beam Evaporation, comprising:
at least one Si/graphene unit layer having an amorphous phase upper silicon thin film and a lower graphene thin film; and
a graphene thin film deposited onto the amorphous phase upper silicon thin film.

2. The multilayer composite anode structure according to claim 1, wherein when the at least one Si/graphene unit layer has a number more than one, a first one of the Si/graphene unit layers is deposited on the anode substrate, and each one of the rest Si/graphene unit layers is deposited on a preceding one.

3. The multilayer composite anode structure according to claim 1, wherein the anode substrate is a copper foil.

4. The multilayer composite anode structure according to claim 1, wherein the at least one Si/graphene unit layer includes 7 Si/graphene unit layers.

5. The multilayer composite anode structure according to claim 4, wherein the thin film of each of the Si/graphene unit layers has a thickness of 50 nm.

6. The multilayer composite anode structure according to claim 1, wherein the at least one Si/graphene unit layer consists of 7 Si/graphene unit layers and the graphene thin film is deposited onto a top surface of the at least one Si/graphene unit layer.

7. The multilayer composite anode structure according to claim 6, wherein the multilayer composite anode structure has a capacitance larger than 1000 mAh/g when tested with a current density being less than 100 mAh/g.

8. The multilayer composite anode structure according to claim 7, wherein the multilayer composite anode structure has a coulombic efficiency in a first charge/discharge cycle larger than 80%, the multilayer composite anode structure has an irreversible capacity in a second charge/discharge cycle less than 20%, and after 30 charge/discharge cycles, the multilayer composite anode structure has a discharge capacity larger than 65% of the discharge capacity of the multilayer composite anode structure in the first charge/discharge cycle.

9. A manufacturing method for an electrode structure, comprising:
providing an Electron Beam Evaporation chamber;
keeping a pressure in the chamber in a range of 4˜10 Pa;
depositing a graphene thin film under a condition that a temperature in the chamber is in a range of 150˜250° C.; and
depositing a silicon thin film on the graphene thin film under a condition that a temperature in the chamber is in a range of 150˜250° C.

10. The method according to claim 9, wherein the graphene thin film is deposited at a first coating velocity of 1000 nm/h and the silicon thin film is deposited at a second coating velocity of 1000 nm/h.

11. The method according to claim 9, wherein the graphene thin film depositing step and the silicon thin film depositing step are repeated 7 times.

12. The method according to claim 11, further comprising:
depositing an additional graphene thin film on the silicon thin film under a condition that a temperature in the chamber is in a range of 150˜250° C. and the silicon thin film depositing step is to be accomplished 7 times.

13. A manufacturing method for an electrode structure, comprising:
providing an Electron Beam Evaporation chamber;
pressurizing the Electron Beam Evaporation chamber;
depositing a graphene thin film in the Electron Beam Evaporation chamber at a first specific temperature; and
depositing a silicon thin film in the Electron Beam Evaporation chamber at a second specific temperature.
